(19) United States
(12) Patent Application Publication
(10) Pub. No.: US 2007/0218255 A1
(43) Pub. Date: Sep. 20, 2007

(54) Films for decorating glass and methods of their production

(76) Inventor: Lorin S. Gray III, Gorham, ME (US)

Correspondence Address: FISH & RICHARDSON PC, P.O. BOX 1022, MINNEAPOLIS, MN, 55440-1022, US

(21) Appl. No.: 11/384,735

(22) Filed: Mar. 20, 2006

(51) Int. Cl. B41M 5/00

(52) U.S. Cl. 428/195.1

(57) ABSTRACT

Films are provided for providing decorative effects on glass, for example, films for replicating the surface texture of architectural glass, or for decorating glass containers. Moreover, methods of making such films are provided.

### TECHNICAL FIELD

This invention relates to films for application to glass, for example to give the appearance of architectural glass, and methods of producing such films.

### BACKGROUND

Frosted, etched and textured (e.g., pebbled, swirled or ribbed) glass sheets and panels have long been prized for their aesthetic qualities. These types of glass, referred to collectively herein as “architectural glass,” are used for decorative purposes in homes and commercial buildings. However, architectural glass, which is generally formed by embossing molten glass or acid-etching sheets of glass, tends to be relatively expensive. Moreover, to retrofit an existing house or other structure by replacing untextured window glass with architectural glass is generally costly and disruptive. Additionally, the processes used to impart a surface texture to glass tend to compromise the strength and shatterproof qualities of the glass.

As a result, films have been developed for adhesion to untextured window glass to simulate the appearance of architectural glass. Some of these films are formed by embossing a texture into a polymeric film, such as a PVC film, for example by passing the film through a nip between an embossing roll and backing roll. Embossing typically does not allow very fine features to be imparted to the film and may not permit a desired pattern to be replicated with high fidelity, due to inherent limitations of the embossing process. Moreover, the embossed pattern may deleteriously affect adhesion of the film to glass due to air pockets in the embossed pattern. In some cases, etched or frosted glass is simulated by printing a pattern onto film or opacifying portions of a film, rather than imparting a surface texture to the film.

### SUMMARY

The invention features films for decorating glass, for example architectural glass films (i.e., films that can be adhered to glass to give the appearance of architectural glass), and methods of making such films. Some preferred films have a surface texture that replicates the surface texture of architectural glass with very high fidelity, e.g., up to 100% fidelity. In some implementations, the films exhibit high heat resistance, scratch resistance and durability. Some preferred films may also include a very fine surface texture, for example with features as small as 300 angstroms (3000 nanometers).

In some aspects, the invention features methods of making films for decorating glass.

In one aspect, the invention features a method including (a) providing a transparent or translucent film substrate; (b) applying a curable coating to a surface of the substrate; (c) imparting a pattern to the coating, the pattern being configured to be visible to the naked eye; and (d) curing the coating to adhere the coating to the film substrate. Some implementations include one or more of the following features. The method further includes applying an adhesive to an uncoated surface of the substrate, the adhesive being capable of adhering the architectural glass film to glass. The cured coating is translucent. The pattern is imparted to the coating by contacting the coated substrate with an engraved roll. The method further includes configuring the pattern to replicate an architectural glass surface texture. The method further includes applying a release sheet to the adhesive. The curing step comprises curing the coating by applying electron beam energy or actinic radiation. The curing step comprises applying the electron beam energy or actinic radiation from a second, opposite surface of the substrate, through the substrate. The method further includes, after curing, cutting the film substrate to a desired size. The cutting step comprises cutting the film to a desired width, e.g., a size selected to fit a window.

In another aspect, the invention features a method of making an architectural glass film including: (a) forming a release sheet by (i) applying a curable coating to a surface of a sheet-form substrate, (ii) imparting a pattern to the coating, the pattern being selected to replicate a desired architectural glass effect; and (iii) curing the coating to adhere the coating to the sheet-form substrate; and (b) casting a hardenable transparent or translucent coating on the release sheet to form the film.

Some implementations include one or more of the following features. The method further includes (c) stripping the film from the release sheet. The pattern is imparted to the coating by contacting the coated substrate with an engraved roll. The method further includes configuring the pattern to be observable with the naked eye in the finished architectural glass film. The method further includes applying an adhesive to a surface of the film opposite the surface that was cast against the release sheet, the adhesive being capable of adhering the architectural glass film to glass. The method further includes applying a release sheet to the adhesive.

In another aspect, the invention features an architectural glass film for decorating glass, comprising a transparent or translucent film substrate having a first surface and a second surface, the first surface being configured to adhere to glass; and a cured coating on the second surface of the substrate, the cured coating bearing a three-dimensional pattern that creates a decorative effect that is visible to the naked eye. The first surface carries an adhesive to adhere the first surface to glass. The coating comprises an acrylate. The film substrate is selected from the group consisting of polyester films, cellulosic films, polystyrene films and acrylic films. The pattern replicates an architectural glass pattern with substantially 100% fidelity. The pattern is configured to replicate a surface texture of architectural glass.

In a further aspect, the invention features an architectural glass film comprising a translucent film having a first surface and a second surface, the first surface being adherable to glass, the second surface of bearing a three-dimensional pattern that replicates a surface texture of architectural glass with substantially 100% fidelity.

Some implementations include one or more of the following features. The film includes a substrate and a textured coating adhered to the substrate. The first surface carries an adhesive to adhere the first surface to glass. The coating includes an acrylate. The substrate is selected from the group consisting of polyester films, cellulosic films, polystyrene films and acrylic films.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a diagrammatic view of a method of forming a film for decorating glass.

FIG. 2 is a diagrammatic view of an alternative method of forming a film for decorating glass.

FIGS. 3-3C illustrate an example of a textured film, with FIG. 3 being a photograph of the film, FIG. 3A being a tally scan representing the surface texture in three dimensions, and FIGS. 3B and 3C being SEM photographs of the film from the top and in cross-section, respectively.

FIGS. 4-4C illustrate a second example of textured film, with FIG. 4 being a photograph of the film, FIG. 4A being a tally scan representing the surface texture in three dimensions, and FIGS. 4B and 4C being SEM photographs of the film from the top and in cross-section, respectively.

Like reference symbols in the various drawings indicate like elements.

### DETAILED DESCRIPTION

We will first describe two alternative methods of forming films for decorating glass, e.g., architectural glass films, and then we will describe various characteristics of preferred films.

Coating a Film Substrate

In one method, a curable liquid is coated onto to a film substrate, a texture is imparted to the coating, e.g., by a mold roll, the coating is cured, and the substrate and cured coating are stripped from the texture-imparting surface. In this case, the architectural glass film includes the substrate and the cured, textured coating. Generally, the uncoated side of the substrate is adhered to the glass that is to be decorated by the film. The surface texture of the architectural glass film will be the inverse of the texture of the mold roll or other texture-applying device (referred to herein as the replicative surface).

The method may include further steps. For example, in some implementations, e.g., when the film substrate is not formed of a material that inherently clings to glass, an adhesive is applied to the uncoated surface of the film substrate and a release sheet may optionally be applied to the adhesive.

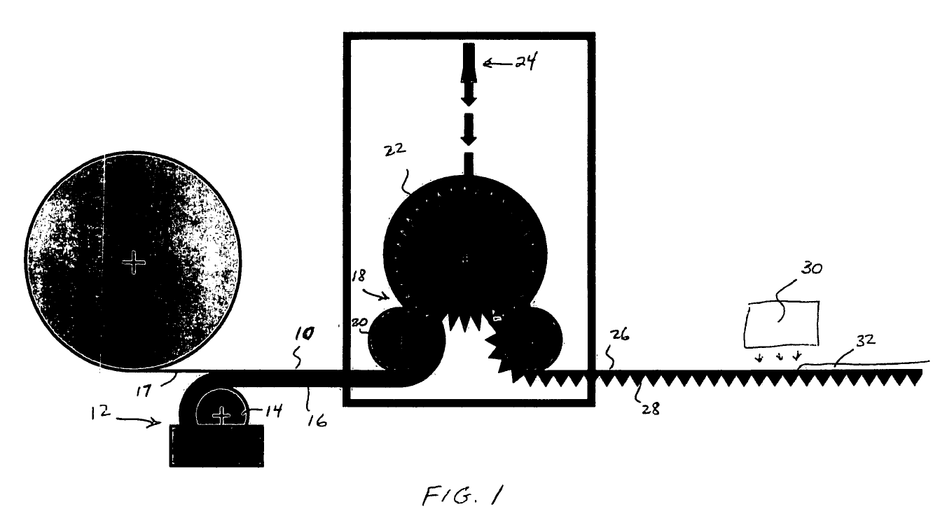

Preferably, the entire process is conducted on a continuous web of material which is drawn through a series of processing stations, e.g., as shown diagrammatically in FIG. 1. Referring to FIG. 1, in one process a web 10, typically a transparent polymeric film, first passes through a coating station 12 at which a coating head 14 applies a wet coating 16 to a surface 17 of the web. Next, the coated web passes through a nip 18 between a backing roll 20 and an engraved roll 22, with the wet coating 16 facing the engraved roll 22. The engraved roll carries a surface texture, the inverse of which is imparted to the wet coating. Nip pressure is generally relatively low (e.g., “kiss” pressure), with the nip pressure being selected based on the viscosity of the coating to prevent the coating from being squeezed off of the web, while still allowing the engraved texture to be imparted to the coating. Typically, higher viscosity coatings and deeper patterns will require relatively higher nip pressures.

After leaving the nip, the coated and textured web passes through a curing station 24, e.g., an electron beam or UV curing device. The coating is preferably cured while it is still in contact with the surface of the engraved roll surface. E-beam energy or actinic radiation is applied from the back surface 26 of the web and passes through the transparent web and cures the coating 16 to form a hardened, textured coating 28 that is firmly adhered to the web 10. At this point, if the web 10 has properties that allow it to self-adhere to glass, the web 10 and cured coating 28 may be spooled and shipped as a finished product, or subjected to any other desired further processing. If web 10 does not in itself adhere to glass, the back surface 26 of web 10 may be coated with an adhesive 32 at a coating station 30.

The coatings 16 and 32 may be applied using any suitable method. Suitable techniques include offset gravure, direct gravure, knife over roll, curtain coating, and other printing and coating techniques.

The engraved roll is one example of a replicative surface that may be used to impart surface texture to the wet coating. Other types of texture-imparting devices may be used. It is generally preferred, however, that the replicative surface be disposed on a rotating endless surface such as a roll, drum, or other cylindrical surface. The coating can be applied directly to the web, before the substrate contacts the roll, as shown in FIG. 1, or alternatively the coating can be applied directly to the roll, in which case the substrate is pressed against the coated roll.

The coating may be cured by thermal curing, electron beam radiation, or UV radiation. Electron beam radiation is preferred in some cases because it can simplify coating penetration and improve coating properties. If a thick coating of a clear material is used, UV radiation may be preferred. Electron beam radiation units are readily available and typically consist of a transformer capable of stepping up line voltage and an electron accelerator. Manufacturers of electron beam radiation units include Energy Sciences, Inc. of Woburn, Mass., and PCT Engineered Systems, LLC, Davenport, Iowa. Suitable UV curing devices are commonly available, e.g., from Fusion, Inc., Gaithersburg, Md.

The adhesive 32 may be curable, e.g., using heat, UV or electron beam radiation. In some cases, the adhesive may not require curing or drying, e.g., if a hot melt is used. If desired, a release sheet may be applied to the adhesive surface to prevent the adhesive from being contaminated or sticking to other surfaces until the film is applied to glass. Alternatively, the adhesive may be formulated to be relatively non-tacky. Suitable adhesives are discussed below.

The substrate film may be any desired transparent or translucent polymeric film to which the curable coating will adhere. Films to which the coating would not normally adhere can be treated, e.g., by flame treatment, corona discharge, or pre-coating with an adhesion promoter. If high heat resistance and durability is desired, polyester films are preferred. Other suitable films include cellulose triacetate, biaxially oriented polystyrene and acrylics. The film may have any desired width that can be accommodated by the available equipment, for example 3 meters wide or wider. The film is preferably delivered to the production line from a continuous roll. At the end of the process, the coated film is generally spooled onto a take-up roll for storage and shipment. However, if desired, a cutting station can be provided (not shown) to slit the film to a narrower width or cut the film into individual units. The film can be cut to window size, either during the manufacturing process or later by a distributor, retailer or end user. Advantageously, the film can be manufactured in very wide widths, and thus can be cut to fit even very large windows. The film substrate may have any desired thickness that is suitable for use in the available processing equipment. Preferably, the film is thin enough to allow it to be flexible, and thick enough to provide durability and ease of handling. Typically, the film thickness is from about 0.001 to 0.005 inch (0.025 to 0.13 mm), preferably 0.002 to 0.004 inch (0.05 to 0.10 mm).

The coating preferably includes an acrylated oligomer, a monofunctional monomer, and a multifunctional monomer for crosslinking. If ultraviolet radiation is used to cure the acrylic functional coating, the coating will also include a photoinitiator as is well known in the art.

Preferred acrylated oligomers include acrylated urethanes, epoxies, polyesters, acrylics and silicones. The oligomer contributes substantially to the final properties of the coating. Practitioners skilled in the art are aware of how to select the appropriate oligomer(s) to achieve the desired final properties. Desired final properties for the release sheet of the invention typically require an oligomer which provides flexibility and durability. A wide range of acrylated oligomers are commercially available from Cytec Surface Specialties Corporation, such as Ebecryl 6700, 4827, 3200, 1701, and 80, and Sartomer Company, Inc., such as CN-120, CN-999 and CN-2920.

Typical monofunctional monomers include acrylic acid, N-vinylpyrrolidone, (ethoxyethoxy)ethyl acrylate, or isodecyl acrylate. Preferably the monofunctional monomer is isodecyl acrylate. The monofunctional monomer acts as a diluent, i.e., lowers the viscosity of the coating, and increases flexibility of the coating. Examples of monofunctional monomers include SR-395 and SR-440, available from Sartomer Company, Inc., and Ebecryl 111 and ODA-N (octyl/decyl acrylate), available from Cytec Surface Specialties Corporation.

Commonly used multifunctional monomers for crosslinking purposes are trimethylolpropane triacrylate (TMPTA), propoxylated glyceryl triacrylate (PGTA), tripropylene glycol diacrylate (TPGDA), and dipropylene glycol diacrylate (DPGDA). Preferably the multifunctional monomer is selected from a group consisting of TMPTA, TPGDA, and mixtures thereof. The preferred multifunctional monomer acts as a crosslinker and provides the cured layer with solvent resistance. Examples of multifunctional monomers include SR-9020, SR-351, SR-9003 and SR-9209, manufactured by Sartomer Company, Inc., and TMPTA-N, OTA-480 and DPGDA, manufactured by Cytec Surface Specialties Corporation.

Preferably, the coating comprises, before curing, 20-50% of the acrylated oligomer, 15-35% of the monofunctional monomer, and 20-50% of the multifunctional monomer. The formulation of the coating will depend on the final targeted viscosity and the desired physical properties of the cured coating. In some implementations, the preferred viscosity is 0.2 to 5 Pascal seconds, more preferably 0.3 to 1 Pascal seconds, measured at room temperature (21-24° C.).

The coating composition may also include other ingredients such as opacifying agents, colorants, slip/spread agents and anti-static or anti-abrasive additives. The opacity of the coating may be varied, for example by the addition of various pigments such as titanium dioxide, barium sulfate and calcium carbonate, addition of hollow or solid glass beads, or addition of an incompatible liquid such as water. The degree of opacity can be adjusted by varying the amount of the additive used.

As mentioned above, a photoinitiator or photoinitiator package may be included if the coating is to be UV cured. A suitable photoinitiator is available from the Sartomer Company under the tradename KTO-46™. The photoinitiator may be included at a level of, for example, 0.5-2%.

The coating may have any thickness that will allow the desired texture to be imparted. Preferred coating thickness will depend on the depth of the features to be imparted. When the process described above is used, it is generally preferred that the overall thickness of the coating is at least twice the depth of the pattern's deepest features. This coating thickness provides a base, beneath the texture, that is at least as thick as the depth of the texture. In some implementations, the coating is at least 0.020 mm thick, preferably at least 0.020 mm thick. In some implementations, the coating has a total thickness of about 0.040 to 0.220 mm. The thickness of the ‘base’ polymer, below the texture, will generally be between 20 micrometers and 60 micrometers (0.020 mm to 0.060 mm) and the ‘texture’ may range from less than 20 micrometers to greater than 160 micrometers (0.020 mm to 0.160 mm).

If it is desired to apply an adhesive to the uncoated side of the substrate, the adhesive may be any type of adhesive that will adhere well to glass and has a desired level of transparency. Some preferred adhesives are optically clear. In some cases, it is desirable to use an adhesive that will allow the architectural glass film to be removed from the glass without leaving a residue, e.g., if it is desirable that the film be removable. In other cases, a permanent adhesive is preferred. Suitable adhesives include, for example, solvent-borne adhesives such as those commercially available from Cytec under the tradename GELVA multipolymer solution; radiation curable adhesives, such as those commercially available from Sartomer, e.g., CN-2921 and blends of CN-3221 and SR-506, for example blended in a ratio of 70:30. The adhesive will include a photoinitiator if UV curing is desired.

Casting Onto a Textured Release Sheet

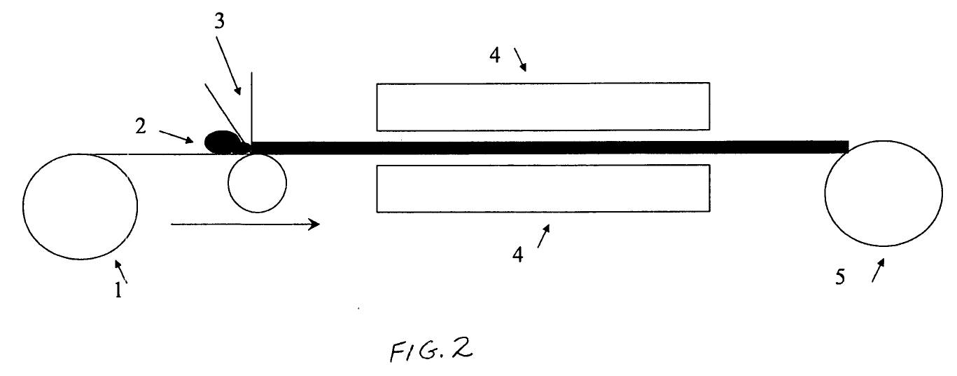

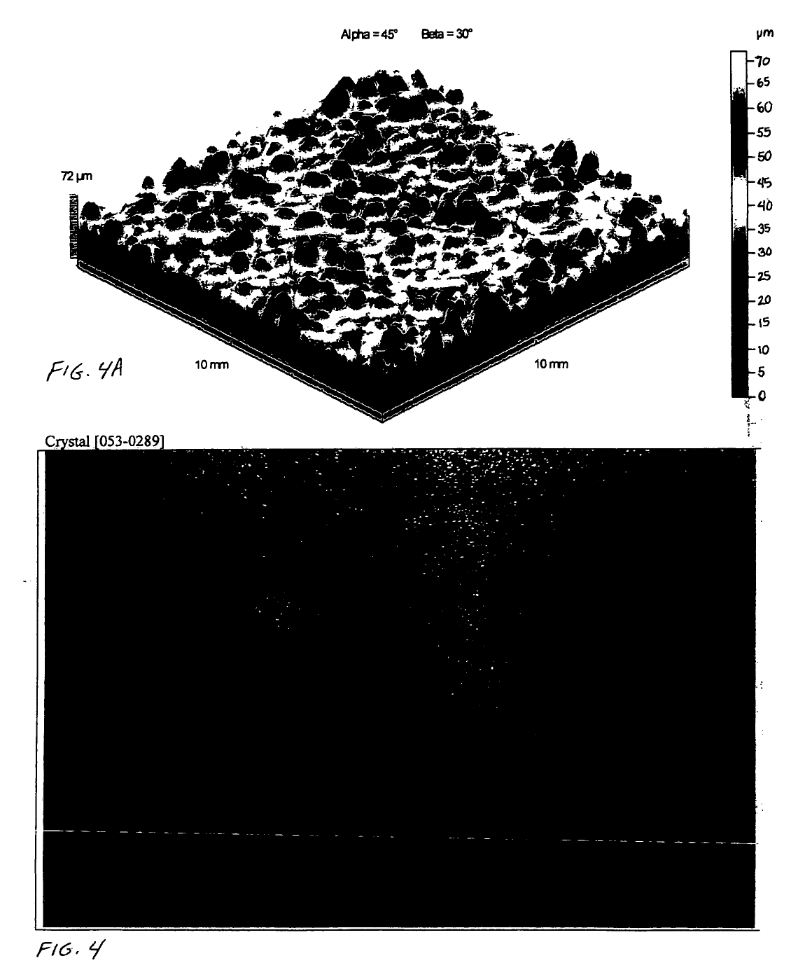

In the second method, shown diagrammatically in FIG. 2, a hardenable liquid is cast onto a release sheet, e.g., a release paper, having a desired surface texture. The liquid is then hardened, or allowed to harden, and the resulting film may be stripped from the release sheet or sold on the release sheet. In this case, the release sheet is acting as a temporary mold, and the surface texture of the resulting architectural glass film will be the inverse of the texture of the release sheet. Thus, the surface texture of the cast film will be substantially identical to the texture of the device (e.g., mold roll) used to impart the texture to the release sheet. The architectural glass film formed by this process will generally include only a single layer, i.e., the cast material, rather than a substrate and coating as discussed above.

Referring to FIG. 2, a roll of release paper (1) with the desired texture for an architectural glass pattern is coated, for example with a polyvinyl chloride plastisol composition (2) of desired clarity, color and any other special effects, at a coating station such as a knife-over-roll coating head (3). The gap between the coater and the paper is set to the desired thickness prior to coating. The paper and plastisol is carried through a series of one or more drying oven(s) to solidify the plastisol into a polyvinyl chloride film. The product may be wound up in place on a re-wind stand (5), be stripped from the paper (not shown), be interleaved and stripped from the paper (not shown) or be given an additional coating, an adhesive for example (also not shown).

In this process, as in the first method described above, an adhesive may be applied to the non-textured surface of the cast film if the film does not inherently adhere to glass. A release paper may be applied to the adhesive, if desired.

The hardenable material may be any of the radiation-curable coating materials discussed above, in which case the coating may be cured by any of the above-described methods. The same coating formulations that are suitable for use in the above-described methods would be suitable in this method as well. Alternatively, the hardenable material may be any of the materials commonly used in forming transparent or translucent cast films, e.g., PVC plastisols and other hardenable polymeric and monomeric materials such as heat-curable polyurethanes. The curable liquids discussed above are preferred in some applications due to their high durability and heat resistance. PVC plastisols are dispersions of finely ground polyvinyl chloride particles in a plasticizer with a high solvency for PVC, for example phthalate esters. Some plastisols are cured at approximately 150° C. to 200° C. to fuse the PVC resin via solvation. Additives include stabilizers to inhibit acid formation or react with formed acid, UV absorbers, thickeners, and a variety of co-solvents as is well known in the field. Suitable plastisols are water-white as supplied and will be clear upon curing/fusing. Additives may be used to increase the opacity of the cast plastisol, for example pigments or glass beads as discussed above.

The release sheet may be formed, for example, by applying a curable coating to one surface of a sheet material, e.g., a paper web, pressing the coated side of the sheet material against a replicative surface having the desired surface effect to cause the coating to conform to the replicative surface, irradiating the coating with electron beam radiation to cure the coating, and stripping the sheet material from the replicative surface with the cured coating adhered to the sheet material.

The sheet material used to form the release sheet may be any type of sheet-like substrate, e.g., paper, metal foil, and plastic film, preferably paper. The substrate should be generally impervious to penetration of the acrylic functional coating to maximize the efficiency of the acrylic functional coating. The substrate is preferably paper with a base coat to prevent penetration of the acrylic functional coating. Most preferably, the base coat is a clay coating at a coat weight of approximately 6 lb/3300ft2 (8.9 g/m2).

To form the release sheet, the sheet material is coated with one of the coating materials described above, including an acrylated oligomer, a monofunctional monomer, and a multifunctional monomer for crosslinking. The coating may also include a siloxane release agent at 2% or less by total weight of the polymerized coating. Preferred acrylated oligomers, monofunctional monomers and multifunctional monomers are discussed above, and these components may be used in the same relative amounts discussed above. The siloxane release agent is added to ensure release of the acrylic functional coating from the replicative surface which imparts the desired surface effect to the polymerized coating. Siloxanes are commercially available from Goldschmidt Chemical Corp., e.g., TEGO Glide ZG-400 and TG RC-704, from Dow Coming Corporation, e.g. 2-8577 Fluid, and from Cytec Surface Specialties Corporation, e.g., Ebecryl 350.

Architectural Glass Films

The patterns imparted by the replicative surface or the textured release sheet have a “macro” aspect which is visible to the naked eye, providing a decorative effect. For example, the viewer may observe a repeating pattern, such as ribs, swirls, or a more complex decorative motif, or an overall frosted or pebbled appearance. At the same time, the patterns is made up of very fine features, as discussed above, allowing the texture to accurately simulate the fine texture of etched or otherwise textured glass. In some instances, for example if a frosted or etched surface texture is used, the pattern reduces the transparency of the glass to which the architectural glass film is applied, at least in certain areas. The light transmission of a particular film is selected to give a desired decorative effect.

The size of the features of the pattern will depend on the decorative effect desired. For frosted glass, and other similar fine-textured effects, the feature size may be near the wavelength of light. In some implementations, such micro-texture features is utilized, with other, different micro-texture features, in such a way that the micro-textures form part of a macro-texture that is visible in the overall pattern. The resulting macro-texture in some cases replicates an existing macro-texture that is used in the manufacture of architectural glass and provides a decorative effect that is visible to the naked eye.

In some implementations, at least some of the features of the pattern are larger than 500 nanometers (5000 angstroms) in the x-y and z dimensions (distance between features and depth of features in all directions, with depth being measured from the top of the feature to its base), and in some cases substantially all of the features are larger than 500 nanometers. For example, the pattern may have a size distribution in which at least 90% of the features are larger than 700 nanometers, and at least 50% of the features are larger than 1000 nanometers. Generally, the size of the features will be larger, e.g., in some patterns the feature size ranges from 1000 to 65,000 nanometers. Generally, the features should be non-uniform, in order to provide the desired textural effects. The pattern may in some cases be configured so that a clear film (a film that does not include any opacifying ingredients) appears opaque to the observer, i.e., objects behind the film are obscured unless directly behind and in contact with the film. In some cases, the pattern may include textured regions and non-textured (flat) regions, the textured regions having greater opacity and providing a decorative effect and the flat regions having greater transparency.

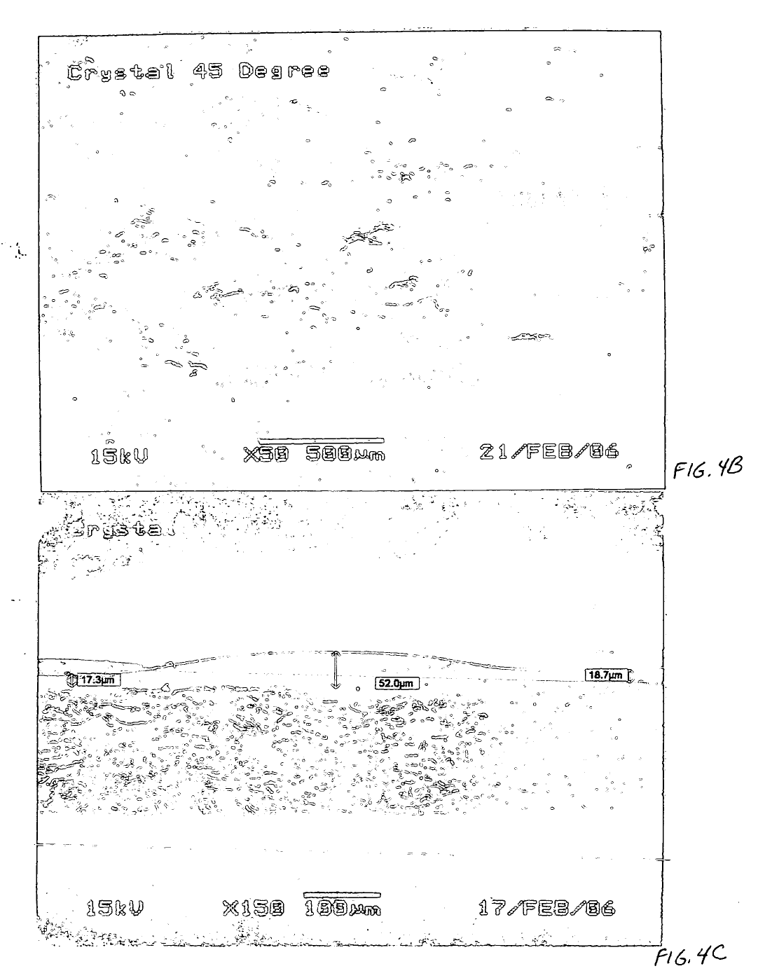

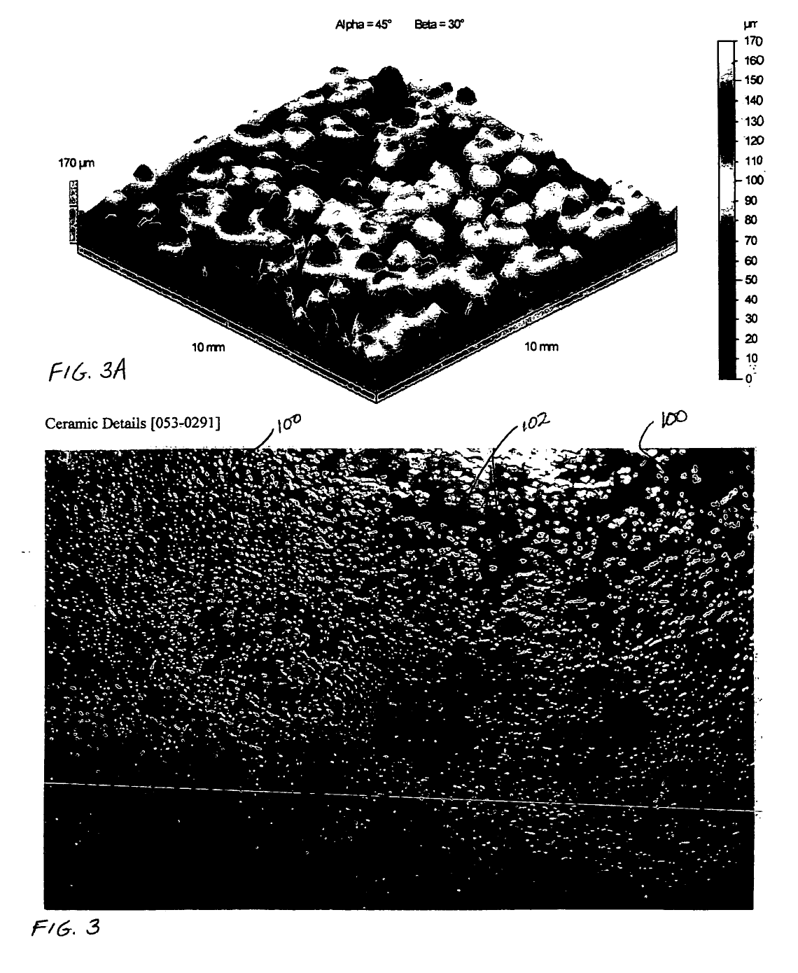

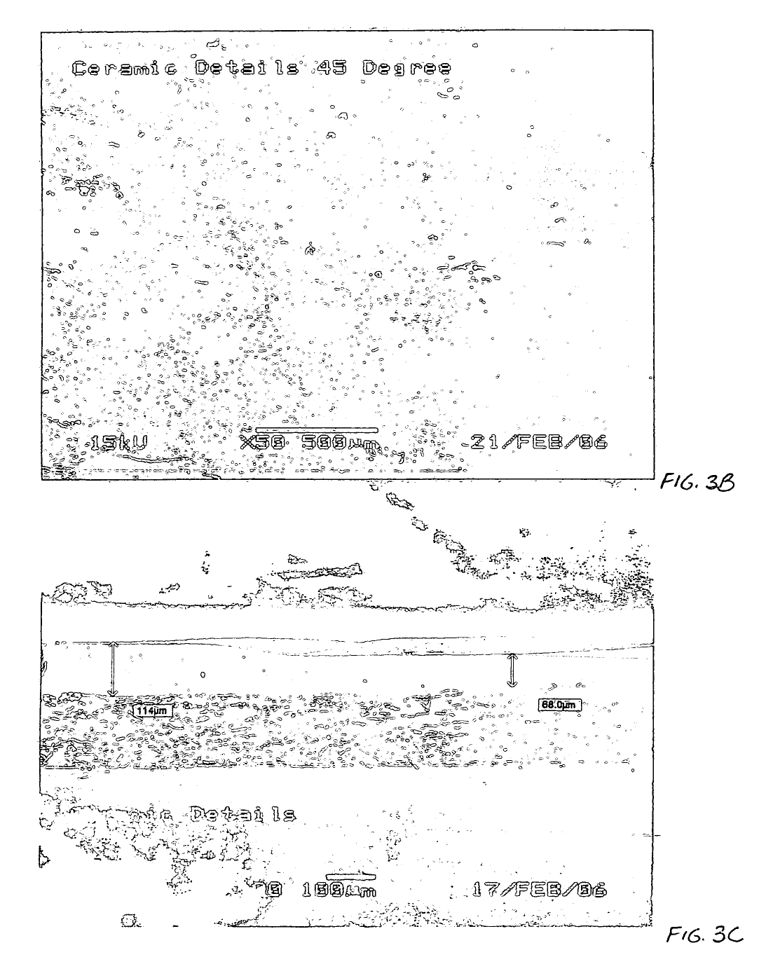

FIGS. 3-3C and 4-4C illustrate two examples of patterns. In the textured film shown in FIG. 3, the pattern includes textured regions 100, shown in detail in FIGS. 3A-3C, and non-textured regions 102 that are completely flat. These flat regions are almost completely transparent, while the textured regions are quite opaque, virtually completely obscuring objects behind the film. In the textured regions, the width of individual features ranges from about 25,000 to 65,000 nanometers, and the depth of individual features ranges from about 5,000 to 12,000 nanometers. In the textured film shown in FIG. 4, the entire surface of the film is more or less uniformly textured, i.e., the film does not include any discernable non-textured areas. However, as illustrated by FIG. 4A, the micro-texture of the film is non-uniform, consisting of “bumps” of varying sizes and shapes. The curvature of the bumps causes the film to be relatively opaque, despite a lack of any opacifying ingredients in the coating composition or film substrate. In this pattern, the average height of the bumps is approximately 3500 nanometers. The average width of individual bumps is also approximately 3500 nanometers, although some of the bumps are grouped together forming longer and wider features.

Other Embodiments

A number of embodiments of the invention have been described. Nevertheless, it will be understood that various modifications may be made without departing from the spirit and scope of the invention.

For example, while it is preferred that the first process described above be performed on a continuous web, with all of the processing stations in-line, steps in the process can be performed off-line if desired. For example, if desired the process through the curing step can be performed on a first production line, and the coated film or a portion thereof can then be rolled up and transported to a separate production line for application of the adhesive and optionally a release sheet.

Moreover, while architectural glass films have been described above, the processes described herein may be used to manufacture other types of films for decorating glass. For example, the films may be used to decorate containers and/or as labels for containers, such as wine bottles. In this case, one surface of the film, typically the untextured surface, may be printed with text, logos or other graphics or indicia.

Accordingly, other embodiments are within the scope of the following claims.

What is claimed is:

1. A method of making a film for decorating glass, the method comprising:
providing a transparent or translucent film substrate;
applying a curable coating to a surface of the substrate;
imparting a pattern to the coating, the pattern being configured to be visible to the naked eye; and
curing the coating to adhere the coating to the film substrate.

2. The method of claim 1 further comprising applying an adhesive to an uncoated surface of the substrate, the adhesive being capable of adhering the film to glass.

3. The method of claim 1 wherein the cured coating is translucent.

4. The method of claim 1 wherein the pattern is imparted to the coating by contacting the coated substrate with an engraved roll.

5. The method of claim 1 further comprising configuring the pattern to replicate an architectural glass surface texture.

6. The method of claim 2 further comprising applying a release sheet to the adhesive.

7. The method of claim 1 wherein the curing step comprises curing the coating by applying electron beam energy or actinic radiation.

8. The method of claim 1 further comprising, after curing, cutting the film substrate to a desired size.

9. A method of making an architectural glass film comprising:
(a) forming a release sheet by
applying a curable coating to a surface of a sheet-form substrate;
imparting a pattern to the coating, the pattern being selected to replicate a desired architectural glass effect; and
curing the coating to adhere the coating to the sheet-form substrate; and
(b) casting a hardenable transparent or translucent coating on the release sheet to form the film.

10. The method of claim 9 further comprising curing the cast hardenable coating by applying thermal energy, electron beam energy or actinic radiation.

11. The method of claim 9 further comprising (c) stripping the film from the release sheet.

12. The method of claim 9 wherein the pattern is imparted to the coating by contacting the coated substrate with an engraved roll.

13. The method of claim 9 further comprising configuring the pattern to be observable with the naked eye in the finished architectural glass film.

14. The method of claim 9 further comprising applying an adhesive to a surface of the film opposite the surface that was cast against the release sheet, the adhesive being capable of adhering the architectural glass film to glass.

15. The method of claim 14 further comprising applying a release sheet to the adhesive.

16. The method of claim 9 further comprising configuring the pattern to have a light transmission of the pattern that provides the desired architectural glass effect.

17. A film for decorating glass, comprising
a transparent or translucent film substrate having a first surface and a second surface, the first surface being configured to adhere to glass; and
a cured coating on the second surface of the substrate, the cured coating bearing a three-dimensional pattern that creates a decorative effect that is visible to the naked eye.

18. The film of claim 17 wherein the first surface carries an adhesive to adhere the first surface to glass.

19. The film of claim 17 wherein the coating comprises an acrylate.

20. The film of claim 17 wherein the coating comprises from about 20-50% of the acrylated oligomer, 15-35% of the monofunctional monomer, and 20-50% of the multifunctional monomer.

21. The film of claim 17 wherein the film substrate is selected from the group consisting of polyester films, cellulosic films, polystyrene films and acrylic films.

22. The film of claim 17 wherein the pattern replicates an architectural glass pattern.

23. An architectural glass film comprising
a translucent film having a first surface and a second surface, the first surface being configured to adhere to glass, the second surface of bearing a three-dimensional pattern that replicates a surface texture of architectural glass with substantially 100% fidelity.

24. The architectural glass film of claim 23 wherein the three-dimensional pattern is made up of features, at least 90% of the features having a size greater than 700 nanometers in the x-y and z dimensions.

25. The architectural glass film of claim 23 wherein the film comprises a substrate and a textured coating adhered to the substrate.

26. The architectural glass film of claim 23 wherein the first surface carries an adhesive to adhere the first surface to glass.

27. The architectural glass film of claim 25 wherein the coating comprises an acrylate.

28. The architectural glass film of claim 25 wherein the coating comprises from about 20-50% of the acrylated oligomer, 15-35% of the monofunctional monomer, and 20-50% of the multifunctional monomer.

29. The architectural glass film of claim 25 wherein the substrate is selected from the group consisting of polyester films, cellulosic films, polystyrene films and acrylic films.
